(19) United States
(12) Patent Application Publication
(10) Pub. No.: US 2012/0013472 A1
(43) Pub. Date: Jan. 19, 2012

(54) Systems and Methods of Monitoring Combustible Gases in a Coal Supply

(75) Inventor: Robert Warren Taylor, Ponte Vedra Beach, FL (US)

(73) Assignee: General Electric Company, Schenectady, NY (US)

(21) Appl. No.: 12/837,040

(22) Filed: Jul. 15, 2010

(51) Int. Cl. G08B 17/10; G01N 21/00

(52) U.S. Cl. 340/632; 356/437

(57) ABSTRACT

A method of monitoring a coal supply includes receiving a sampled level of at least one combustible gas in the coal supply from a combustible gas sensor device embedded in the coal supply, analyzing the sampled level to identify an accumulated combustible gas condition, and indicating a combustible gas alert in response to the accumulated combustible gas condition.

### BACKGROUND OF THE INVENTION

The subject matter disclosed herein related to systems and methods of monitoring combustible gases, and more particularly relates to systems and methods of monitoring combustible gases in a coal supply.

Coal contains volatile compounds that tend to oxidize in the presence of oxygen. Upon oxidation the volatile compounds create gases, which may be combustible. For example, coal contains carbon, which oxidizes in the presence of oxygen to form carbon monoxide, a gas known to be combustible. These combustible gases may accumulate in coal that is sitting in a pile or confined space, creating heated pockets that ultimately may spontaneously combust. A fire may break-out, presenting a hazard and wasting the coal supply. The risk of fire is more prevalent with lower-ranking forms of coal that tend to be used today.

Turning the sitting coal may reduce the fire risk by allowing the combustible gases to escape into the atmosphere, but typically the coal is turned without knowing whether combustible gases have accumulated. Instead, the coal generally is turned arbitrarily or continuously. Temperature sensors can be employed to identify heat within the coal as a proxy for combustible gas accumulation. However, heat is merely a proxy for the source of the problem, and the heat may not be present until spontaneous combustion is eminent. What the art desires are systems and methods of monitoring combustible gases in a coal supply, which may facilitate taking remedial action to alleviate the accumulation.

### SUMMARY OF THE INVENTION

A method of monitoring a coal supply includes receiving a sampled level of at least one combustible gas in the coal supply from a combustible gas sensor device embedded in the coal supply, analyzing the sampled level to identify an accumulated combustible gas condition, and indicating a combustible gas alert in response to the accumulated combustible gas condition.

A system of monitoring a coal supply includes one or more combustible gas sensor devices and a control unit. The combustible gas sensor device is operable to detect a local combustible gas level in the coal supply. The control unit is operable to indicate a combustible gas alert based at least in part on the combustible gas level detected by at least one of the combustible gas sensor devices.

Other systems, devices, methods, features, and advantages will be apparent or will become apparent to one with skill in the art upon examination of the following figures and detailed description. All such additional systems, devices, methods, features, and advantages are intended to be included within the description and are intended to be protected by the accompanying claims.

### BRIEF DESCRIPTION OF THE DRAWINGS

The present disclosure may be better understood with reference to the following figures. Matching reference numerals designate corresponding parts throughout the figures, and components in the figures are not necessarily to scale.

FIG. 1 is a schematic diagram illustrating an embodiment of a system of monitoring combustible gases in a coal supply.

FIG. 2 is a block diagram illustrating another embodiment of a system of monitoring combustible gases in a coal supply.

FIG. 3 is a block diagram illustrating an embodiment of a method of monitoring combustible gases in a coal supply.

FIG. 4 is a perspective view of an embodiment of a combustible gas sensor device, illustrating a housing of the sensor device partially cut-away to exposed schematically illustrated interior components.

### DETAILED DESCRIPTION OF THE INVENTION

Described below are embodiments of systems and methods of monitoring combustible gases in a coal supply, such as in a coal pile or a coal bunker. The coal supply may contain combustible gases due to the oxidation of volatile components in the coal. The combustible gases may accumulate, create the risk of spontaneous combustion or other risks. Monitoring the combustible gases in the coal supply facilitates taking remedial action before such risks become reality.

Any type of coal supply may be monitored for combustible gases using the systems and methods described herein. For example, one type of coal supply is a field of freshly mined coal that is being held for shipment. Typically, mined coal is maintained in a coal pile that may be as large as a football field or larger. From the field, the coal may be transported by truck, train, or otherwise. During transit the coal may be maintained in a confined space, such as in a truck bed or a train car. The coal is often unloaded from the truck or train into another coal pile. For example, coal destined for a coal-burning boiler may be stored in a coal pile near the boiler. The coal pile may store a supply of coal sufficient to fuel the boiler for an extended period, such as a period of sixty to one hundred days. Just before being consumed in the boiler, the coal is usually transferred to a bunker that holds a supply of coal sufficient to fuel the boiler for a shorter period, such as a period of six to ten hours.

In each of these locations, combustible gases may develop in the coal. These combustible gases may accumulate, creating risks that can be mitigated by turning the coal so that the combustible gases escape into the atmosphere. Normally, large coal piles, such as piles of freshly mined coal or coal awaiting transfer to a boiler, are turned continuously or arbitrarily with a bulldozer or other suitable machine. Small coal stores, such as coal in a train car or bunker, usually are not turned due to the confined space. Instead, small coal stores are usually moved or consumed within a short time period to reduce the risk of fire. For example, coal within a train car may be moved out of the train car instead of being left in the train car where combustible gases may accumulate. As another example, all of the coal within a bunker may be transferred to and burned within the associated boiler before the boiler is shutdown.

Alternatively, the systems and methods described herein permit detecting and indicating the accumulation of combustible gases in the coal supply. Thereby, it may no longer be necessary to turn the coal supply arbitrarily or continuously, or to move coal from a train car promptly, or to deplete coal in a bunker before an associated boiler is shut-down. Instead, the systems and methods permit taking remedial action, such as turning or moving the coal supply, in response to a detected accumulation of combustible gas.

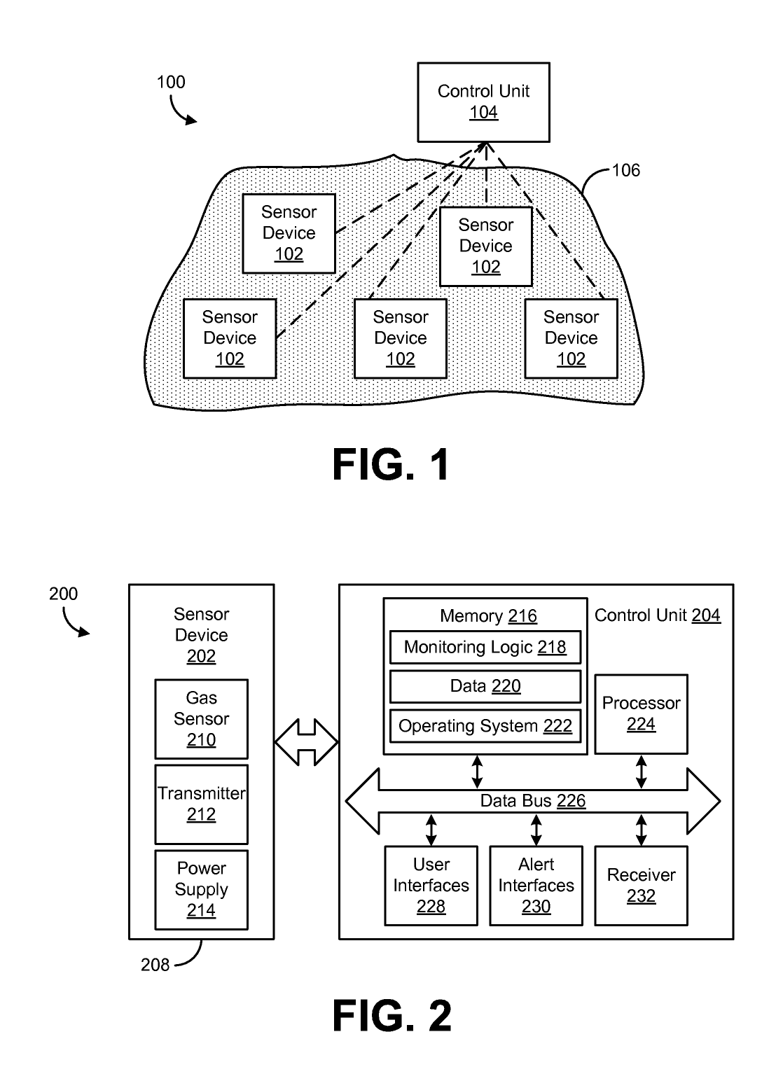

FIG. 1 is a schematic diagram illustrating an embodiment of a system 100 of monitoring combustible gases in a coal supply. The system 100 includes at least one combustible gas sensor device 102 and a combustible gas control unit 104. The combustible gas sensor device 102 is operable to detect the level of one or more combustible gases in the coal supply 106 and to transmit an indication of the detected combustible gas level to the control unit 104. The control unit 104 is operable to receive the detected combustible gas level, to analyze the detected combustible gas level to identify the accumulation of combustible gas, and to indicate a combustible gas alert based at least in part on the accumulation of combustible gas.

The combustible gas sensor device 102 may detect a combustible gas such as carbon monoxide, hydrogen, acetylene, or any other type of combustible gas that may be present in a coal supply, among others or combinations thereof. The combustible gas sensor device 102 detects a level of the combustible gas in the coal supply, such as an amount or concentration of the combustible gas in the coal supply, and transmits the detected level to the control unit 104. The control unit 104 receives the level of the combustible gas, processes the detected combustible gas level to identify whether the combustible gas has accumulated in the coal supply, and in certain cases indicates a combustible gas alert. The combustible gas alert may correlate to an accumulation of combustible gas associated with a risk of spontaneous combustion. The combustible gas alert may be indicated by sounding an alarm, by sending a message, by storing data, by reporting data, or by generating a control action, among others or combinations thereof. The indication of the combustible gas alert may permit taking a remedial action to avoid a fire in the coal supply. For example, a human may be alerted of the need to turn the coal supply with a bulldozer, so that the accumulated combustible gases can escape into the atmosphere.

In some embodiments, the system includes a number of combustible gas sensor devices 102, as shown in FIG. 1. The sensor devices 102 can be embedded throughout the coal supply 106 in disparate locations. The use of multiple sensor devices 102 facilitates monitoring combustible gas levels in multiple sampling locations throughout the coal supply 106. The combustible gas sensor device 102 can communicate with the control unit 104 using a known transmission medium, such as via radio-frequency communication, infrared communication, optical communication, or any other electromagnetic, magnetic, or other communication medium. For example, the combustible gas sensor device 102 may include a transmitter and the control unit 104 may include a corresponding receiver. The transmitter and receiver may be configured to communicate with each other using the known transmission medium. In some embodiments, both the combustible gas sensor device 102 and the control unit 104 include both a transmitter and a receiver, facilitating two-way communication between the sensor device 102 and the control unit 104. Although not shown, the system 100 may also include more than one control unit 104, in which case each of the combustible gas sensor devices 102 may be in communication with one or more of the control units 104, and each of the control units 104 may be in communication with some or all of the combustible gas sensor devices 102.

In some embodiments, the control unit 104 indicates the combustible gas alert in response to a rate of increase of the combustible gas level at a particular location in the coal supply. To identify the rate of increase, the control unit 104 may compare the combustible gas level detected by any one gas sensor device 102 to previous levels detected by the same gas sensor device 102 or similar devices in nearby locations in the coal supply 106. If the combustible gas level increases at a rate that suggests combustible gas accumulation, the control unit 104 may indicate the alert so that remedial action can be taken to alleviate the accumulation. For example, a rapid increase in the combustible gas accumulation rate may indicate spontaneous combustion is eminent.

In other embodiments, the control unit 104 indicates the combustible gas alert in response to the level detected at a particular location in the coal supply exceeding the level detected at another location in the coal supply. To identify the increased level, the control unit 104 may compare the level detected by one gas sensor device 102 to the level detected by another gas sensor device 102. The control unit 104 also may compare the level detected by the one gas sensor device 102 to an average, mean, or other derived representation of the levels detected by other gas sensor devices 102, such as all of the other gas sensor devices 102, a select subset of the gas sensor devices 102 positioned near the one gas sensor device 102, or another subset of the gas sensor devices 102. The control unit 104 may indicate the alert if the level detected in one location exceeds the level to which it is compared, such as by a certain amount, by a certain percentage, or for a certain period of time, among others or combinations thereof. In still other embodiments, the detected level may be compared to a reference level, such as a level that has been predetermined to be maximum allowable level, such as through experimental or theoretical calculations based on historical data, derived data, statistical data, or environmental conditions, among others or combinations thereof.

In some embodiments, the system 100 may be configured to identify a location where combustible gas is accumulating in the coal supply 106. The location may be identified in any feasible manner. For example, each gas sensor device 102 may have an address or identity that is communicated to the control unit 104 along with the detected combustible gas level. As another example, the control unit 104 may detect the strength of the signal transmitted by the gas sensor device 102 to estimate the location of the sensor device 102 in the coal supply 106. Knowing the location of the gas sensor device 102 facilitates taking remedial action in the specific location where the combustible gas is accumulating.

In some embodiments, the system 100 may sample the combustible gas in accordance with a sampling rate. The sampling rate may be adjustable from an initial a baseline or threshold value. For example, when the system 100 identifies that combustible gases have begun accumulating, the sampling rate may be increased above the baseline or threshold rate so that the gas accumulation can be monitored with greater resolution. If the accumulation abates itself, the sampling rate may be returned to the baseline or threshold value. If the accumulation does not abate itself or further increases, the sampling rate may be maintained at the increased value or may be further increased. Such a configuration may facilitate accurate detection of combustible gas accumulation while preserving the battery life of the sensor device 102.

FIG. 2 is a block diagram illustrating another embodiment of a system 200 of monitoring combustible gases in a coal supply, schematically illustrating one embodiment of a combustible gas sensor device 202 and one embodiment of a control unit 204. As shown, the combustible gas sensor device 202 generally includes a housing 208, a gas sensor 210, a transmitter 212, and a power supply 214. The housing 208 may be relatively enclosed to contain the components of the sensor device 202, yet may be permeable to the combustible gases so that the gases can reach the gas sensor 210. An embodiment of a housing is described below with reference to FIG. 4. The gas sensor 210 may be operable to detect the level of the combustible gas in coal supply. The level may correlate to a concentration, amount, or other parameter of the combustible gas that facilitates determining its accumulation in the coal supply. For example, the gas sensor 210 may measure the concentration of the combustible gas per volume of the housing 208 of the sensor device 202. In some embodiments, the gas sensor 210 may include a laser, such as a tunable diode laser or a quantum cathode laser, although other sensor technologies can be employed.

The gas sensor 210 may be in communication with the transmitter 212, which transmits to the control unit 204 the level of the combustible gas detected by the gas sensor 210. The transmitter 212 also may transmit an identity of the sensor device 202 or a location of the sensor device 202 in the coal supply. The transmitter 210 may be any type of transmitter as described above, such as a radio-frequency transmitter. The transmitter 212 may be powered by the power supply 214. In embodiments, the transmitter 212 may be a low-wattage transmitter to reduce the power demands on the power supply.

The power supply 214 may be a battery having a battery life sufficient to power the components of the sensor device 202 for an extended time period, such as a time period that exceeds the expected time period that the sensor device 202 will be implanted in the coal supply. For example, the power supply 214 may have a battery life of about 100 to 120 days. Such a battery life may be appropriate for sensor devices 202 that are implanted in a coal pile that supplies a coal-burning boiler, as such coal piles are often sized to fuel the boiler for an extended period, such as a period of about 60 to 90 days. Such a configuration may facilitate monitoring the combustible gas with a sensor device 202 embedded in the coal supply for a maximum expected period that the coal supply with be sitting or stored in a single location.

In some embodiments, the sampling rate of the gas sensor device 202 may be adjusted to preserve the power supply 214. For example, the gas sensor device 202 may sample the combustible gas level in accordance with a baseline or threshold sampling rate and may transmit the sampled level to the control unit 204 at the same rate so that the control unit 204 may process the sampled level. If the control unit 204 determines that combustible gas has begun accumulated (e.g. a combustible gas warning condition as opposed to a combustible gas alert condition), the control unit 204 may cause the gas sensor device 202 to increase the sampling rate. For example, the control unit 204 may have a transmitter that communicates the increased sampling rate to a receiver of the gas sensor device 202. Alternatively, the gas sensor device 202 may determine the sampling rate based at least in part on the sampled combustible gas level, such as using a processor. The sampling rate may be maintained or further increased until the accumulation abates itself, in which case the sampling rate may be returned to the baseline rate. Such a configuration facilitates monitoring the combustible gas level for an extended period of time using a gas sensor device 202 having a relatively small battery. For example, the gas sensor device 202 may transmit sampled data at long intervals, such as about every hour or two hours, until a warning condition develops.

The control unit 204 may be operable to receive the detected level of combustible gas from the gas sensor device 202 and to at least partially perform one or more of the methods described herein for monitoring combustible gases in a coal supply. The control unit 204 may include a receiver 232. The receiver 232 may be in communication with one or more of the gas sensor devices 202, such as for receiving detected levels from the gas sensor devices 202, among other things. The control unit 204 may include a memory 216 that stores combustible gas monitoring logic 218 and data 220. The combustible gas monitoring logic 218 may be executed to perform at least a portion of one of the methods described herein. For example, the combustible gas monitoring logic 218 may be executed to identify an accumulated combustible gas condition and/or to cause a combustible gas alert to be indicated. The data 220 may be operational data or parameters, historical data, reference data, and the like. The memory 216 also may include an operating system 222. A processor 224 may utilize the operating system 222 to execute the combustible gas monitoring logic 218, and in doing so, also may utilize the data 220. A data bus 226 may provide communication between the memory 216 and the processor 224. Users may interface with the control unit 204 via one or more user interface devices 228, such as a keyboard, mouse, control panel, or any other devices capable of communicating data to and from the control unit 204. The control unit 204 may be in communication with one or more alert interfaces 230, which may facilitate generating one or more of the alerts described herein. For example, in one embodiment the alert may be a visual alert, such as a light, in which case the alert interface 230 may be in communication with a light bulb. In another embodiment, the alert may be an audible alert, in which case the alert interface 230 may be in communication with a speaker. In yet another embodiment, the alert may be a message, in which case the alert interface 230 may be a network interface operable to send a message over a network. These are merely examples.

Though not shown, the control unit 204 can comprise multiple controllers and/or can communicate with other memories and/or controllers for accessing distributed data and/or distributing processing and/or providing redundant processing. For example, each impulse cleaning device may be controlled by a different controller, wherein each controller is in operable communication (and optionally with one or more centralized controllers) to facilitate coordinating the phased ignition and detonation.

The application references block diagrams of systems, methods, apparatuses, and computer program products, according to at least one embodiment described herein. It will be understood that at least some of the blocks of the block diagrams, and combinations of blocks in the block diagrams, respectively, may be implemented at least partially by computer program instructions. These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of blocks in the block diagrams discussed in detail in the descriptions below.

These computer program instructions also may be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions also may be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based electronics, programmable consumer electronics, mini-computers, or mainframe computers, among others or combinations thereof.

Application programs that are components of the systems and methods described herein may include routines, programs, components, data structures, etc., that implement certain abstract data types and perform certain tasks or actions. In a distributed computing environment, the application program (in whole or in part) may be located in local memory, or in other storage. In addition, or in the alternative, the application program (in whole or in part) may be located in remote memory or in storage to allow for circumstances where tasks are performed by remote processing devices linked through a communications network.

Various embodiments disclosed herein may include one or more special purpose computers, systems, and/or particular machines that monitor combustible gases in a coal supply. A special purpose computer or particular machine may include a wide variety of different software modules as desired in various embodiments. In certain embodiments, these various software components may be utilized to monitor combustible gases in a coal supply and/or to identify the presence of a combustible gas condition in a coal supply. Certain embodiments described herein may have the technical effect of monitoring combustible gases in a coal supply. Additionally, certain embodiments may have the technical effect of identifying a combustible gas alert condition in the coal supply. In this regard, the risk of combustible gas accumulation, spontaneous combustion and/or fire may be controlled or avoided.

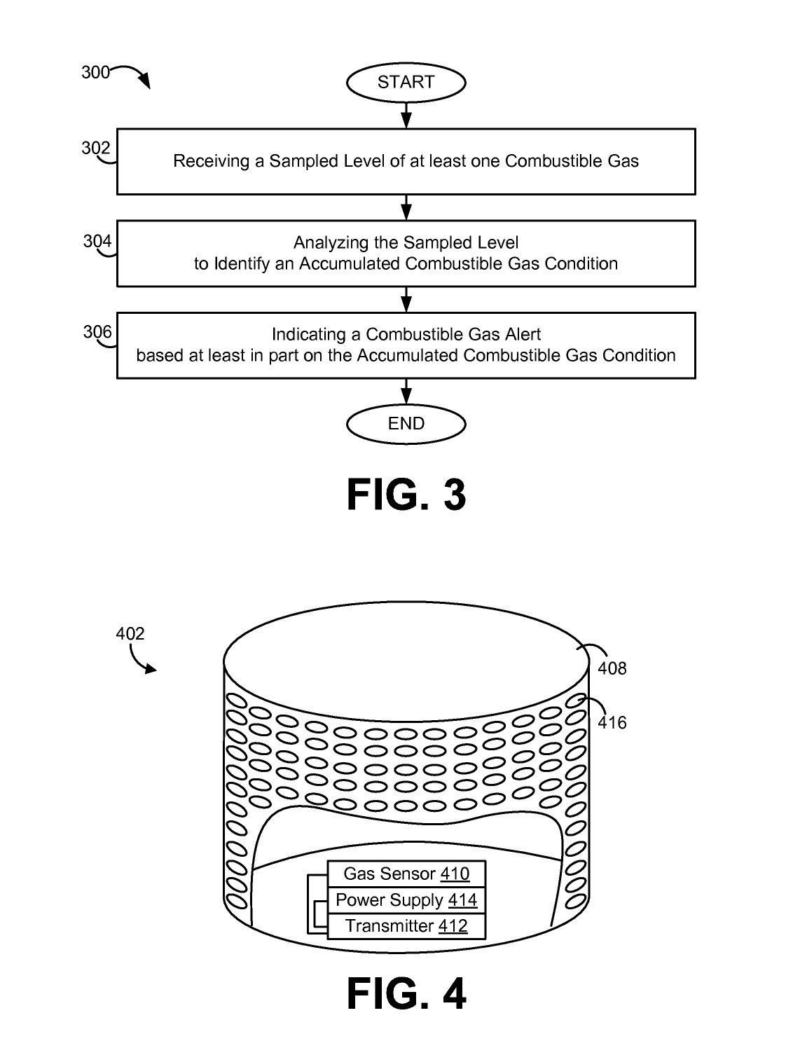

The control unit and associated combustible gas monitoring logic and other computer-executable instructions can, at least in part, be used to facilitate implementing the method described below. In particular, FIG. 3 is a block diagram illustrating an embodiment of a method of monitoring combustible gases in a coal supply. In block 302, a sampled level of a combustible gas in the coal supply is received. In some embodiments, the sampled level is received from a sensor device embedded in the coal supply. The sampled level may indicate the level of the combustible gas in a sampling location, such as a local vicinity of the sensor device. The sampled level may be a measure of an amount or concentration of the combustible gas in the sampling location. In some embodiments, the sampled level is a measure of the concentration of the combustible gas per volume of the sensor device. For example, the sampled level may be a measure of the concentration per volume of carbon monoxide, hydrogen, or acetylene within the sensor device. Other parameters also may be employed that correlate to a level, amount, or concentration of the combustible gas.

In particular embodiments, the sampled level is received by a receiver in a control unit from a transmitter in a sensor device. The sampled level may be received in accordance with a sampling rate. The sampling rate may be predetermined based on, for example, a battery life of the sensor device and a length of time that the sensor device is expected to remain embedded in the coal supply. In some embodiments, the sampling rate may be adjusted based on conditions detected in the coal supply. For example, the sample rate may be adjusted to a combustible gas warning rate, which may be an increased rate, in response to a combustible gas warning condition, which may correlate to an indication that combustible gas has begun accumulating in the coal supply.

In block 304, the sampled level of the combustible gas is analyzed to identify an accumulated combustible gas condition. Analyzing the sampled level may include comparing the sampled level to at least one reference level, comparing a rate of change of the sampled level to a reference rate of change, or a combination thereof. In response to the comparison, an accumulated combustible gas condition may be identified. The accumulated combustible gas condition may correlate to an accumulation of combustible gas that presents a risk of spontaneous combustion in the coal supply.

In embodiments in which analyzing the sampled level includes comparing a rate of change of the sampled level to a reference rate of change, block 304 may include (i) determining a sampled rate of change, (ii) determining a reference rate of change, and (iii) comparing the sampled rate of change to the reference rate of change.

The sampled rate of change may be determined by comparing the sampled combustible gas level to a previous sampled combustible gas level. The sampled level and the previous level may have been detected at the same location in the coal supply at different sampling times, such as by the same sensor device. For example, the sampled level may represent the combustible gas level most recently detected by the sensor device at the sampling location, while the previous level may represent a combustible gas level previously detected by the sensor device at the sampling location, either immediately prior to the sampled level or otherwise. In such embodiments, the comparison of the sampled level and the previous level in block 304 may represent a rate of change in the combustible gas level at the sampling location. For example, the comparison may represent the rate of change in the combustible gas concentration about the sensor device. However, other configurations are possible.

The reference rate of change may be a detected value, a stored value, a value derived from a detected or stored value, or a combination thereof. The reference rate of change also may be an array of rates or a representation of more than one rate, such as a graph or an equation. For example, the reference rate of change may be a maximum allowable rate of change.

Once the sampled and reference rates are determined, the rates may be compared to identify an accumulated combustible gas condition. In some embodiments, the accumulated combustible gas condition may be identified in response to the sampled rate of change exceeding the reference rate of change, as an absolute matter, by a certain amount, by a certain percentage, or for a certain amount of time, among others or combinations thereof.

In embodiments in which analyzing the sampled level includes comparing the sampled level to at least one reference level, the reference level may be a detected value, a stored value, a value derived from a detected or stored value, or a combination thereof. The reference level also may be an array of values or a representation of more than one value, such as a graph or an equation.

In cases in which the reference level is a detected value, the reference level may correlate to a sampling location in the coal supply that is the same as or is different from the sampled level. The reference level also may correlate to a sampling time that is the same as or is different from the sampled level. The reference level and the sampled level may be detected by the same sensor device embedded in the coal supply or by different sensor devices. For example, the reference level and the sampled level may be detected at about the same point in time using different sensor devices, at different points in time using the same sensor device, or at different points in time using different sensor devices.

In cases in which the reference level is a stored value, the reference level may be based at least in part on a historical value, a theoretical value, an experimental value, a statistically determined value, or a tabulated value, among others or combinations thereof. For example, the reference level may be an expected combustible gas level based on values previously detected in the coal supply or a comparable coal supply under comparable environmental conditions, such as comparable temperature and moisture conditions. The reference level also may be a maximum allowable or threshold value based on detected conditions, experimental models, theoretical models, or combinations thereof. For example, the reference value may be a maximum allowable value calculated based at least in part on recent sampled levels in the sampling location, and may further consider recent sampled levels in other locations in the coal pile.

Still other reference levels can be employed. For example, the reference level may be an average of the local levels detected by some or all of the sensor devices in the coal supply, at either the same or different points in time. The reference level also may be derived from more than one local levels previously detected by the sensor device. For example, the reference level may be an average of previously detected levels, an array of previously detected levels, or a graph of previously detected levels, among others.

In other particular embodiments, the sampled level and the reference level may correspond to different locations in the coal supply at the same point in time. For example, the sampled level and the reference level may be detected by different sensor devices in the coal supply at the same sampling time. In such embodiments, the comparison between the sampled level and the reference level in block 304 may represent a difference in the combustible gas level in two different locations in the coal supply at the same point in time.

Once the sampled and reference levels are determined, the levels may be compared to identify an accumulated combustible gas condition. In some embodiments, the accumulated combustible gas condition may be identified in response to the sampled level exceeding the reference level, such as absolutely, by a certain amount, by a certain percentage, or for a certain amount of time, among others or combinations thereof.

In block 306, a combustible gas alert is indicated based at least in part on the identification of the accumulated combustible gas condition. Indicating a combustible gas alert may include providing an alarm, such as an audible alarm, a visual alarm, a local alarm, or a remote alarm, among others; sending a message, such as an email message, an SMS message, a fax message, or an instant message, among others; initiating an automated telephone notification; storing data; reporting data; or generating a control action, among others or combinations thereof. The indication of the combustible gas alert may indirectly result in a remedial action being taken to ameliorate the build-up of combustible gas in the coal pile. For example, a human operator may respond to the indication by taking a remedial action, such as by causing the coal supply to be turned with a bulldozer. The indication of the combustible gas alert condition also may directly result in a remedial action being taken to ameliorate the build-up of combustible gas. For example, a robotic apparatus may respond to the indication by automatically taking a remedial action, such as by automatically turning the coal supply with a bulldozer.

FIG. 4 is a perspective view of an embodiment of a combustible gas sensor device 402, illustrating a housing 408 of the sensor device 402. In FIG. 4, the housing 408 is shown partially cut-away so that the gas sensor 410, the transmitter 412, and the power supply 414 can be schematically illustrated within the housing 408. As shown, the housing 408 has one or more walls and a number of gas entry openings 416 formed through at least one of its walls. The walls are relatively enclosed to protect the components of the sensor device 402 while allowing the gas to reach the gas sensor 410 through the gas entry openings 416. The gas entry openings 416 may be generally smaller than the individual coal pieces, to limit the ingress of coal through the openings 416 into the sensor device. In the illustrated embodiment, the housing 408 is substantially cylindrical in-shape, which may facilitate relatively even gas distribution throughout the housing 408, although any other shape is possible. In some embodiments, the housing 408 may be formed from a magnetic material, such as steel, or the housing may have a magnet associated with at least one of the walls. The magnetic material or magnet may facilitate removing the gas sensor device 402 from the coal supply.

An embodiment of a combustible gas sensor, such as combustible gas sensor 402, may be suited for use with the coal supply of a power plant that features at least one pulverized-coal fired boiler. Typically, such a power plant is associated with a long-term coal supply stored in a coal pile and a short-term coal supply stored near the boiler in a bunker. The coal usually reaches the power plant via a train or ship. From the train or ship, the coal may be placed in the coal pile using a first conveyor. As the coal is spread along the first conveyor, gas sensor devices may be associated with the coal, and as the coal exits the first conveyor, the gas sensor devices may become embedded in the coal pile. The number of gas sensor devices embedded in the pile may vary depending on the size of the pile, the strength of the gas sensor transmitters, and the expected time period that coal is expected to sit. For example, and not to limit the disclosure in any manner, effective monitoring may be achieved with gas sensor devices placed about 10 ft. apart to about 100 ft. apart, such as about 20 ft. apart to about 60 ft. apart. A single gas sensor device may monitor an area of about 25 sq. ft. to about 600 sq. ft., such as about 80 sq. ft. to about 400 sq. ft. It is not uncommon for a coal pile that supplies such a power plant to be as large as a football field or larger and to be fifty feet deep or deeper. A coal pile of this size may be monitored using about 15 to about 80 gas sensor devices, such as about 30 to about 50 sensor devices. The gas sensor devices may have a battery life suited for lasting as least as long as the maximum amount of time the coal is expected to remain in the coal pile. Such a coal pile may store enough coal to fuel the boiler or boilers for a period between about 10 and about 120 days, such as between about 30 days and about 90 days. During that time, the gas sensor devices may be used to monitor combustible gases in the coal pile as described above. Each gas sensor device may have transmitter suited for transmitting a signal at least as far as the maximum distance from the coal pile to the control unit, which may be positioned near the coal pile, such as in a control room. For example, the signal may be transmitted every couple of hours, such as every one to two hours, until the control unit begins to notice gas accumulation, at which point monitoring may occur at an increased interval.

Shortly before being transferred to the boiler, the coal may be drawn from an underside of the coal pile into an underground pit. In the pit, the coal may travel along a second conveyor toward a crusher house. The second conveyor may be associated with a metal removing device or a trapped steel recovery device, such as a magnetic strip or bar that extracts scrap metal from the coal so that the metal does not enter the crusher house. The metal removing device may be utilized to remove the gas sensor devices from the coal, permitting reuse of the sensor devices. The crusher house may have a crusher, wherein the coal is crushed to chunks, such as chunks of about gravel size (e.g. chunks having a diameter in the range of about ⅜ inch to about ½ inch). From the crusher house, the crushed coal may be transferred to a bunker adjacent to the boiler using a third conveyor. In some cases, gas sensor devices may be reintroduced into the coal supply traveling along the third conveyor, and as the coal exits the third conveyor into the bunker, the gas sensor devices may become embedded therein. Typically such a bunker houses a short-term supply of coal, such as enough coal to fuel the boiler for a period of about 2 hours to 14 hours, such as about 6 hours to 10 hours. For effective monitoring, a suitable number of gas sensors devices may be embedded in the coal depending on the size of the bunker, which may vary. Immediately prior to entering the boiler, the coal may be transferred from the bunker to a pulverizer using a fourth conveyor. The fourth conveyor also may be associated with a metal removing device, such as a magnet, to facilitate removing the gas sensor devices from the coal supply so that the devices do not enter the pulverizer. The pulverizer may pulverize the coal into fine particles, which may be transferred to the boiler where the coal is burned.

It should be noted that gas sensor devices may also be associated with the coal in other locations, such as in a coal pile near a surface mine or strip mine, or in a train car or ship car as the coal is being transported. In such cases, different gas sensor devices may be embedded in the coal in different locations, with the gas sensor devices being embedded in the coal upon reaching a location and being removed from the coal upon leaving the location. Alternatively, the gas sensor devices may remain embedded in the coal as it moves between at least two locations or throughout its journey, such as from the mine, during transport, and at the plant. In any case, the gas sensor devices should have a suitable battery life to facilitate monitoring the goal for the expected time it may remain in the coal. The control unit also may be movable, or alternatively, the gas sensor devices may be configured to communicate with a number of different control units, one in each of the disparate locations where the coal is expected to be monitored. The gas sensor devices may be reusable, although it may be necessary to replace or recharge the power supply periodically.

The systems and methods described herein facilitate monitoring combustible gases in a coal supply. The systems and methods facilitate detecting an accumulation of combustible gas that presents a risk of spontaneous combustion or fire. Early and direct detection is facilitated by widespread monitoring throughout a large coal supply. The monitoring may be more direct than temperature-sensing systems and methods, which monitor the temperature of the coal supply as a proxy for combustible gas accumulation. The monitoring also may be more immediate than temperature-sensing systems and methods, as the temperature of the coal supply may not be appreciably elevated until the accumulation of combustible gases is too advanced to permit remedy. Combustible gas accumulation may be monitored throughout the coal supply, including deep within the coal supply, such as fifty feet below the surface of the coal supply or more. Thus, remedial action can be taken in response to the identification of accumulated combustible gases in the coal supply, as opposed to arbitrarily or continuously. Lower ranking fuels, such as sub-bituminous or lignite coal, can be safely stored despite their increased percentage of volatile compounds, and spontaneous combustion and fire may be less likely to occur, reducing waste. It may be less necessary to eliminate fire or reduce the temperature of the coal by spraying the coal with water or by infusing the coal with steam, both of which decrease the efficiency of the boiler when such coal is burned therein.

While particular embodiments of systems and methods of monitoring combustible gases in a coal supply have been disclosed in detail in the foregoing description and figures for purposes of example, those skilled in the art will understand that variations and modifications may be made without departing from the scope of the disclosure. For instance, features illustrated or described as part of one embodiment can be used on another embodiment to yield a still further embodiment. All such variations and modifications are intended to be included within the scope of the following claims and their equivalents.

At least the following is claimed:

1. A method of monitoring a coal supply, the method comprising:
receiving a sampled level of at least one combustible gas in the coal supply from at least one combustible gas sensor device embedded in the coal supply;
analyzing the sampled level to identify an accumulated combustible gas condition; and
indicating a combustible gas alert in response to the accumulated combustible gas condition.

2. The method of claim 1, wherein the sampled level of the at least one combustible gas comprises one or more of the following: an amount of the combustible gas in a sampling location or a concentration of the combustible gas in the sampling location.

3. The method of claim 1, wherein the at least one combustible gas comprises one or more of the following: carbon monoxide, hydrogen, and acetylene.

4. The method of claim 1, wherein analyzing the sampled level to identify an accumulated combustible gas condition comprises determining a rate of change of the sampled level in a sampling location.

5. The method of claim 1, wherein analyzing the sampled level to identify an accumulated combustible gas condition comprises:
determining a sampled rate of change;
determining a reference rate of change; and
comparing the sampled rate of change to the reference rate of change.

6. The method of claim 5, wherein determining a sampled rate of change comprises comparing the sampled level to a previous level, the previous level corresponding to the same location in the coal supply at a previous time.

7. The method of claim 5, wherein the accumulated combustible gas condition is identified in response to the sampled rate of change exceeding the reference rate of change by a predefined amount, by a predefined percentage, for a predefined time, or a combination thereof.

8. The method of claim 1, wherein analyzing the sampled level to identify an accumulated combustible gas condition comprises comparing the sample level to at least one reference level.

9. The method of claim 8, wherein the accumulated combustible gas condition is identified in response to the sample level exceeding the reference level by a predefined amount, by a predefined percentage, for a predefined time, or a combination thereof.

10. The method of claim 1, wherein indicating a combustible gas alert comprises one or more of the following: generating a visual alarm, generating an audible alarm, sending an email message; sending an SMS message; sending a faxed message; sending an instant message; initiating an automated telephone notification; storing data; reporting data; or generating a control action.

11. The method of claim 1, further comprising adjusting a sampling rate based at least in part on the analysis of the sampled level.

12. A system of monitoring a coal supply, the system comprising:
one or more combustible gas sensor devices, each combustible gas sensor device operable to detect a local combustible gas level in the coal supply; and
a control unit operable to indicate a combustible gas alert based at least in part on the combustible gas level detected by at least one of the combustible gas sensor devices.

13. The system of claim 12, wherein each combustible gas sensor device includes:
a housing having at least one gas entry opening, and
a gas sensor positioned in the housing.

14. The system of claim 13, wherein the housing either comprises a magnetic material or is associated with a magnet.

15. The system of claim 12, wherein each gas sensor includes one or more of the following: a tunable diode laser or a quantum cathode laser.

16. The system of claim 12, wherein each gas sensor is operable to detect one or more of the following gases: carbon monoxide, hydrogen, or acetylene.

17. The system of claim 12, wherein:
each combustible gas sensor device further comprises:
a transmitter operable to communicate with the control unit, and
a power supply; and
the control unit is operable to:
determine a sampling rate of each combustible gas sensor device based at least in part on the local combustible gas level detected by that combustible gas sensor device; and
communicate the sampling rate to that combustible gas sensor device, the sampling rate being optimized to extend a life of the power supply.

18. The system of claim 12, wherein the control unit comprises:
a receiver for receiving the local combustible gas level from at least one gas sensor device; and
logic operable to:
analyze the local combustible gas level to identify an accumulated combustible gas condition; and
indicate a combustible gas alert in response to the accumulated combustible gas condition.

19. The system of claim 18, wherein the local combustible gas level is a concentration of combustible gas per volume of the gas sensor device.

20. The system of claim 19, wherein the logic operable to analyze the local combustible gas level is operable to determine a rate of change of the concentration of the combustible gas per volume of the gas sensor device.
